(19) United States
(12) Patent Application Publication
(10) Pub. No.: US 2012/0285084 A1
(43) Pub. Date: Nov. 15, 2012

(54) Vertical garden assembly

(76) Inventor: Pang-Ling Hu, Taipei City (TW)

(21) Appl. No.: 13/068,442

(22) Filed: May 11, 2011

(51) Int. Cl. A01G 25/00; A01G 1/00

(52) U.S. Cl. 47/39

(57) ABSTRACT

A vertical garden assembly has a frame, multiple pot mounts and a circulating irrigation device. The frame has multiple lateral rods and multiple longitudinal rods arranged in a crisscross pattern to define multiple hanging segments on the lateral rods. Each lateral rod is inclined to a horizontal line to define a high end and a low end. The pot mounts are mounted on the hanging segments. The circulating irrigation device is connected to the pot mounts and has a duct assembly, a reservoir and a pump. The duct assembly has multiple lateral ducts and longitudinal ducts communicating with each other. The lateral ducts are connected to the hollow pot mounts. The reservoir is mounted at a position below the low ends of the lateral rods and is connected with the duct assembly. The pump is mounted between and connected with the duct assembly and the reservoir.

### BACKGROUND OF THE INVENTION

1. Field of the Invention

The present invention relates to a vertical garden assembly, and more particularly to a vertical garden assembly that is hung on an outer wall of a building and has a circulating irrigation device using rainwater.

2. Description of Related Art

Vertical gardens are mounted on outer walls of buildings to improve aesthetic appearance of the buildings and the city. A conventional vertical garden comprises a frame and multiple plant pots. The frame is mounted securely on an outer wall of a building and comprises multiple lateral rods and longitudinal rods arranged in a crisscross pattern to define multiple hanging segments on the lateral rods. The pot mounts are hung on the hanging segments on the frame and can hold a plant pot and soil inside. Accordingly, plants can be cultivated in the plant pots or the pot mounts to make the outer wall of the building look green.

However, the plants in the pot mounts have to be irrigated with water with manpower to keep the plants alive, so to irrigate all the plants in a conventional vertical garden is laborious and time-consuming.

To overcome the shortcomings, the present invention tends to provide a vertical garden assembly to mitigate or obviate the aforementioned problems.

### SUMMARY OF THE INVENTION

The main objective of the invention is to provide a vertical garden assembly that is laborsaving and timesaving in use.

The vertical garden assembly has a frame, multiple pot mounts and a circulating irrigation device. The frame has multiple lateral rods and multiple longitudinal rods arranged in a crisscross pattern to define multiple hanging segments on the lateral rods. Each lateral rod is inclined to a horizontal line to define a high end and a low end that is at a position lower than that of the high end. The pot mounts are hollow and are mounted on the hanging segments on the frame. Each pot mount has a passage defined through two sides of the pot mount. The circulating irrigation device is connected to the pot mounts and has a duct assembly, a reservoir and a pump. The duct assembly has multiple lateral ducts and multiple longitudinal ducts communicating with each other. The lateral ducts are connected to and communicate with the hollow pot mounts and are mounted through the passages of the pot mounts. The reservoir is mounted at a position below the low ends of the lateral rods of the frame and is connected with the duct assembly. The pump is mounted between and connected with the duct assembly and the reservoir. The pump has an input end and an output end. The input end is connected to the reservoir, and the output end is connected to the duct assembly via a connecting pipe.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a vertical garden assembly in accordance with the present invention;

FIG. 2 is an enlarged side view in partial section of the pot mount of the vertical garden assembly in FIG. 1; and

FIG. 3 is an enlarged cross sectional front view of the pot mount of the vertical garden assembly in FIG. 1.

### DETAILED DESCRIPTION OF PREFERRED EMBODIMENT

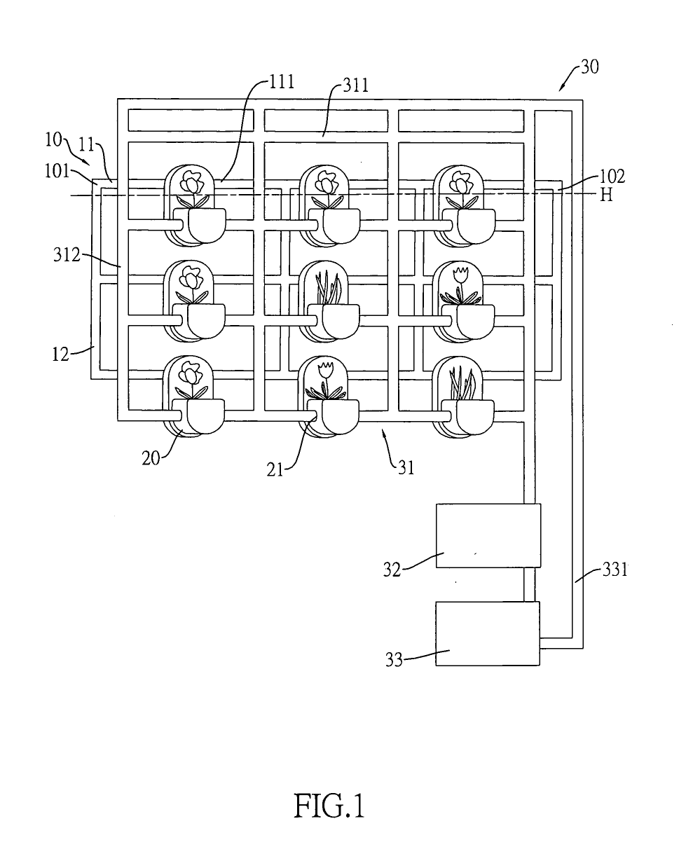

With reference to FIG. 1, a vertical garden assembly in accordance with the present invention comprises a frame 10, multiple pot mounts 20 and a circulating irrigation device 30.

The frame 10 is mounted securely on an outer wall of a building and comprises multiple lateral rods 11 and multiple longitudinal rods 12 arranged in a crisscross pattern to define multiple hanging segments 111 on the lateral rods 11. Each lateral rod 11 is inclined to a horizontal line H to define a high end 101 and a low end 102 that is at a position lower than that of the high end 101.

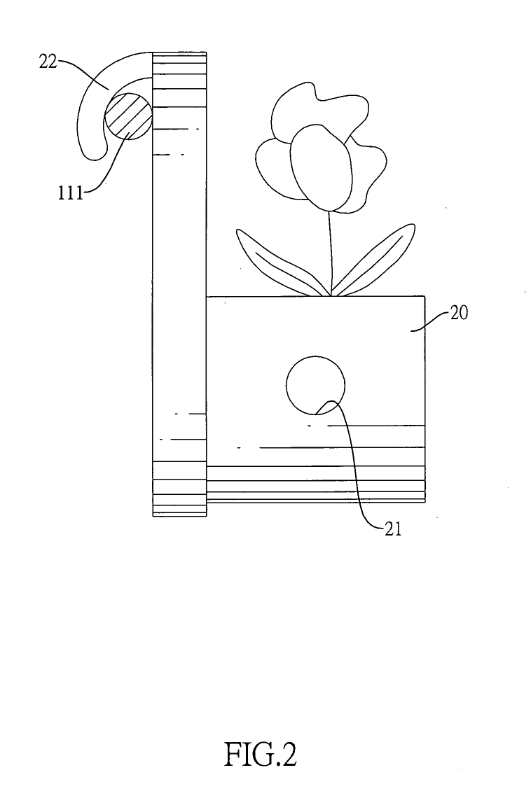

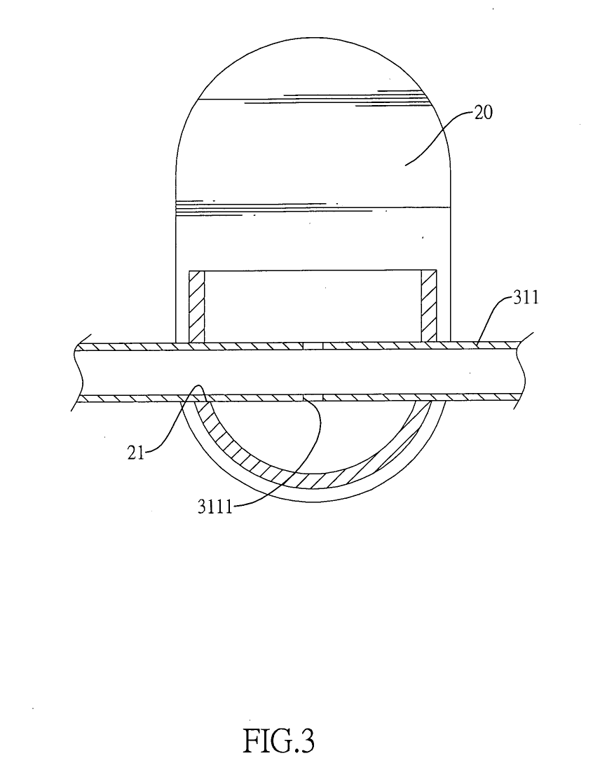

With reference to FIGS. 2 and 3, the pot mounts 20 are hollow to contain plant pots and soil inside and are mounted on the hanging segments 111 on the frame 10. Preferably, the pot mounts 20 are hung on the hanging segments 111 of the frame 10, and each pot mount 20 has a hook 22 mounted on the top of the pot mount 20 and hung on a corresponding hanging segment 111 of the frame 10. Each pot mount 20 has a passage 21 defined through two sides of the pot mount 20.

The circulating irrigation device 30 is connected to the pot mounts 20 and comprises a duct assembly 31, a reservoir 32 and a pump 33.

The duct assembly 31 comprises multiple lateral ducts 311 and multiple longitudinal ducts 312 communicating with each other. The lateral ducts 311 are connected to and communicate with the hollow pot mounts 20 and are mounted through the passages 21 of the pot mounts 20. Each lateral duct 311 is connected to at least one pot mount 20 and has multiple openings 3111 defined through the lateral duct 311 at intervals and at positions inside at least one corresponding pot mount 20. Accordingly, the pot mounts 20 can communicate with each other via the lateral ducts 311. Because the lateral ducts 311 are connected to the pot mounts 20 that are hung on the inclined lateral rods 11, each lateral duct 311 is also inclined and has a high end and a low end. In addition, the lateral ducts 311 and the longitudinal ducts 312 are arranged in a crisscross pattern corresponding to that of the frame 10.

The reservoir 32 is mounted at a position below the low ends 102 of the lateral rods 11 of the frame 10 and is connected with the duct assembly 30.

The pump 33 is mounted between and is connected with the duct assembly 31 and the reservoir 32. The pump 33 has an input end and an output end. The input end is connected to the reservoir 32, and the output end is connected to the duct assembly 33 via a connecting pipe 331.

In use, the plants in the pot mounts 20 can be irrigated with rainwater on raining days. The redundant rainwater that is beyond the soil's absorbing capability can flow into and be stored in the reservoir 32 via the inclined lateral ducts 311 and longitudinal ducts 312 of the duct assembly 31. Accordingly, the water stored in the reservoir 32 can be pumped to the pot mounts 20 by the pump 33 and via the ducts 311,312 of the duct assembly 31 on non-rainy days. With the gravity effect, the water can automatically irrigate the plants in the pot mounts 20 with the inclined lateral ducts 311 and the longitudinal ducts 312 of the duct assembly 31. Therefore, the circulating irrigation device 30 can irrigate the plants automatically and is laborsaving and timesaving in operation.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vertical garden assembly comprising:
a frame comprising multiple lateral rods and multiple longitudinal rods arranged in a crisscross pattern to define multiple hanging segments on the lateral rods, and each lateral rod being inclined to a horizontal line to define a high end and a low end that is at a position lower than that of the high end;
multiple hollow pot mounts mounted on the hanging segments on the frame, and each pot mount having a passage defined through two sides of the pot mount; and
a circulating irrigation device connected to the pot mounts and comprising
a duct assembly comprising multiple lateral ducts and multiple longitudinal ducts communicating with each other, and the lateral ducts connected to and communicating with the hollow pot mounts and mounted through the passages of the pot mounts;
a reservoir mounted at a position below the low ends of the lateral rods of the frame and connected with the duct assembly; and
a pump mounted between and connected with the duct assembly and the reservoir and having an input end connected to the reservoir and an output end connected to the duct assembly via a connecting pipe.

2. The vertical garden assembly as claimed in claim 1, wherein the pot mounts are hung on the hanging segments of the frame; and
each pot mount has a hook mounted on the pot mount and hung on a corresponding hanging segment of the frame.

3. The vertical garden assembly as claimed in claim 2, wherein each lateral duct has multiple openings defined through the lateral duct at positions inside at least one corresponding pot mount.

4. The vertical garden assembly as claimed in claim 1, wherein each lateral duct has multiple openings defined through the lateral duct at positions inside at least one corresponding pot mount.
